(19) United States
(12) Patent Application Publication
(10) Pub. No.: US 2012/0080122 A1
(43) Pub. Date: Apr. 5, 2012

(54) Steel for nitriding use and nitrided part

(76) Inventors: Tetsushi Chida, Tokyo (JP); Toshimi Tarui, Tokyo (JP); Daisuke Hirakami, Tokyo (JP)

(21) Appl. No.: 13/261,068

(22) PCT Filed: Jun. 14, 2010
(86) PCT No.: PCT/JP2010/060406

§ 371 Date: Dec. 8, 2011

(30) Foreign Application Priority Data
Jun. 17, 2009 (JP) 2009-144422

(51) Int. Cl. B32B 15/04; C22C 38/18; C22C 38/02; C22C 38/12; C22C 38/04; C22C 38/06; C22C 38/14

(52) U.S. Cl. 148/318; 420/103

(57) ABSTRACT

The present invention lowers the strength before nitriding to improve the machinability, while deepens the effective hardened case of the nitrided case for improving the fatigue strength. It provides steel for nitriding use containing, by mass %, C: 0.05 to 0.30%, Si: 0.003 to 0.50%, Mn: 0.4 to 3.0%, Cr: 0.2 to 0.9%, Al: 0.19 to 0.70%, V: 0.05 to 1.0%, and Mo: 0.05 to 0.50%, having contents of Al and Cr satisfying 0.5%≦1.9Al+Cr≦1.8%, and having a balance of Fe and unavoidable impurities.

### TECHNICAL FIELD

The present invention relates to steel for nitriding use which secures workability and strength and which may be treated by gas nitriding, plasma nitriding, gas nitrocarburizing, salt bath nitrocarburizing, or other nitrided to give a hard nitrided case and to a nitrided part obtained by nitriding steel for nitriding use and having a hard nitrided case at the surface layer.

### BACKGROUND ART

Automobiles and various industrial machines uses numerous parts which have been hardened at their surfaces for the purposed of improving the fatigue strength. As typical case hardening treatment methods, carburization, nitriding, Induction hardening, etc. may be mentioned. Gas nitriding, plasma nitriding, gas nitrocarburizing, salt bath nitrocarburizing, and other nitriding differ from other methods in that the treatment is performed at a low temperature of the transformation point or less, so have the advantage that the heat treatment distortion can be reduced.

Among the types of nitriding, gas nitriding performed in an ammonia atmosphere gives a high surface hardness, but the nitrogen is slow in diffusion, so in general over 20 hours of treatment time is required.

Further, gas nitrocarburizing, salt bath nitrocarburizing, and other nitrocarburizing performed by a bath or an atmosphere containing carbon in addition to nitrogen can increase the diffusion rate of the nitrogen. As a result, according to nitrocarburizing, it is possible to obtain a 100 μm or more effective hardened case depth in several hours. Therefore, nitrocarburizing is a technique suitable for improvement of the fatigue strength.

However, to obtain a part with a high fatigue strength, it is necessary to make the effective hardened case much deeper. To deal with this problem, to increase the effective hardened case hardness and depth, steels to which nitride-forming alloy elements are suitably added are being proposed (for example, PLTs 1, 2, 6, and 9).

Further, techniques for improving the workability and nitriding characteristics by not only the chemical composition of the steel, but also by controlling the steel microstructure are being proposed (for example, PLTs 3 to 5, 7, and 8).

### CITATION LIST

### Patent Literature

PLT 1 Japanese Patent Publication (A) No. 58-71357
PLT 2 Japanese Patent Publication (A) No. 4-83849
PLT 3 Japanese Patent Publication (A) No. 7-157842
PLT 4 Japanese Patent Publication (A) No. 2007-146232
PLT 5 Japanese Patent Publication (A) No. 2006-249504
PLT 6 Japanese Patent Publication (A) No. 05-025538
PLT 7 Japanese Patent Publication (A) No. 2006-022350
PLT 8 Japanese Patent Publication (A) No. 8-176732
PLT 9 Japanese Patent Publication (A) No. 7-286256

### SUMMARY OF INVENTION

### Technical Problem

However, compared to when treating a steel material by carburization, the current mainstream technique for improving fatigue strength, when treating the steels described in PLTs 1 to 4 by nitriding, the effective hardened case depth has been insufficient. Further, with a steel which contains a large amount of carbon, the hardness of the part becomes higher before nitriding. For this reason, there is the problem that high carbon steel falls in machinability and the loss at the time of forging or machining becomes higher.

The steel described in PLT 5 is improved in the workability (broachability), but conversely has led to a drop in surface hardness.

The steel described in PLT 6 uses nitriding to improve the wear resistance and fatigue strength, but improving the strength inside the steel improves the fatigue strength, so there was the problem of inferior machinability.

The steels described in PLTs 7 to 9 secure effective hardened case depths when nitrided by defining the compositions of ingredients and the steel microstructures, but the effective hardened case depths were not sufficient.

The present invention was made to solve the above problem and has as its object to provide steel for nitriding use which reduces the strength before nitriding to improve the machinability and reduce the manufacturing cost, while enables the effective hardened case to be made deeper to improve the fatigue strength and to provide a nitride part which nitrides the steel for nitriding use to increase the hardness and depth of the nitrided case of the surface layer.

### Solution to Problem

The inventors studied the compositions and microstructures by which deeper effective hardened cases than in the prior art are obtained by gas nitriding, plasma nitriding, gas nitrocarburizing, salt bath nitrocarburizing, or other nitriding and further studied the machinability when producing a nitrided part from steel for nitriding use and the hardness etc. of the final part.

As a result, the inventors discovered that Cr and Al form precipitates at the time of nitriding and thereby contribute to improvement of the surface hardness, in particular that the addition of Al improves the surface hardness, while if excessively including Cr and Al, the effective hardened case depth starts to fall and that to increase the effective hardened case depth, it is necessary to control the contents of Cr and Al to a suitable relationship etc.

The present invention was made based on these discoveries and has as its gist the following:

(1) Steel for nitriding use characterized by containing, by mass %,

C: 0.05 to 0.30%,

Si: 0.003 to 0.50%,

Mn: 0.4 to 3.0%,

Cr: 0.2 to 0.9%,

Al: 0.19 to 0.70%,

V: 0.05 to 1.0%, and

Mo: 0.05 to 0.50%,

having contents of Al and Cr satisfying

0.5%≦1.9Al+Cr≦1.8%, and

having a balance of Fe and unavoidable impurities.

(2) Steel for nitriding use as set forth in the above (1), characterized by further containing, by mass %, one or both of

Ti: 0.01 to 0.3% and

Nb: 0.01 to 0.3%.

(3) Steel for nitriding use as set forth in the above (1) or (2), characterized by further containing, by mass %,

B: 0.0005 to 0.005%.

(4) Steel for nitriding use as set forth in the above (1) or (2), characterized in that an area rate of one or a total of both of bainite and martensite is 50% or more.
(5) Steel for nitriding use as set forth in the above (3), characterized in that an area rate of one or a total of both of bainite and martensite is 50% or more.
(6) A nitrided part characterized by containing, by mass %,

C: 0.05 to 0.30%,

Si: 0.003 to 0.50%,

Mn: 0.4 to 3.0%,

Cr: 0.2 to 0.9%,

Al: 0.19 to 0.70%,

V: 0.05 to 1.0%, and

Mo: 0.05 to 0.50%,

having contents of Al and Cr satisfying

0.5%≦1.9Al+Cr≦1.8%,

having a balance of Fe and unavoidable impurities,

having a nitrided case at its surface, and

having a surface hardness of 700 HV or more.

(7) A nitrided part as set forth in the above (6) characterized by further containing, by mass %, one or both of

Ti: 0.01 to 0.3% and

Nb: 0.01 to 0.3%.

(8) A nitrided part as set forth in the above (6) or (7) characterized by further containing, by mass %:

B: 0.0005 to 0.005%

(9) A nitrided part as set forth in the above (6) or (7), characterized in that an area rate of one or a total of both of bainite and martensite is 50% or more.
(10) A nitrided part as set forth in the above (8), characterized in that an area rate of one or a total of both of bainite and martensite is 50% or more.
(11) A nitrided part as set forth in any one of the above (6), (7), and (10), characterized in that the nitrided case has an effective hardened case depth of 300 to 450 μm.
(12) A nitrided part as set forth in the above (8), characterized in that the nitrided case has an effective hardened case depth of 300 to 450 μm.
(13) A nitrided part as set forth in the above (9), characterized in that the nitrided case has an effective hardened case depth of 300 to 450 μm.

### Advantageous Effects of Invention

According to the present invention, it is possible to provide steel for nitriding use which may be nitrided to obtain a deep effective hardened case.

Further, according to the present invention, it is possible to obtain a nitrided part which does not require many manhours for machining before hardening treatment and which has little heat treatment distortion accompanying hardening treatment.

Further, the nitrided case of the nitrided part of the present invention has a sufficient hardness and has a deep effective nitrided case, so it is possible to raise the fatigue strength of the nitrided part.

### BRIEF DESCRIPTION OF DRAWINGS

FIG. 1 is a view showing the relationship between the 1.9Al+Cr and the effective nitrided case depth.

FIG. 2 is a view showing the relationship between the 1.9Al+Cr and the surface (nitrided case) hardness.

FIG. 3 is a view showing a ½ cross-section of one tooth of a gear part of one embodiment of the present invention.

### DESCRIPTION OF EMBODIMENTS

In the present invention, steel for nitriding use means steel which is used as a material for a nitrided part.

The steel for nitriding use of the present invention is produced by hot working a steel slab. The nitrided part of the present invention can be obtained by hot working the steel for nitriding use of the present invention, then nitriding it or by hot working a steel slab having ingredients within the same range as the steel for nitriding use of the present invention, then nitriding it.

The steel for nitriding use of the present invention is cold worked and, if necessary, machined etc. to obtain the final product shape or a steel slab is directly hot worked into the final product shape or hot worked into a shape close to the final product and machined to the final product shape, then nitrided to thereby obtain a nitrided part.

In the present invention, “nitriding” means the treatment for causing nitrogen to diffuse in the surface layer of a ferrous material and hardening the surface layer and is considered to include “nitrocarburizing” as well.

“Nitrocarburizing” is treatment for causing nitrogen and carbon to diffuse in the surface layer of a ferrous metal material and harden the surface layer.

As typical types of nitriding, gas nitriding, plasma nitriding, gas nitrocarburizing, salt bath nitrocarburizing, etc. may be mentioned. Among these, gas nitrocarburizing and salt bath nitrocarburizing are types of nitrocarburizing.

Further, the fact that the product is a nitrided part can be confirmed by the fact that the surface layer is hardened and the surface layer rises in nitrogen concentration. In particular, a nitrocarburized part has a hardened surface layer of 100 μm or more and has a deep effective hardened case.

First, in the present invention, the reasons for limiting the chemical composition of the steel material will be explained. The limitations on the chemical composition are applied to either of the steel for nitriding use and nitrided part of the present invention.

C is an element which raises the hardenability and is effective for improvement of the strength and further is an element which causes the precipitation of alloy carbides during nitriding and contributes to the precipitation strengthening of the nitrided case. If C is less than 0.05%, the necessary strength is not obtained, while if over 0.30%, the strength becomes too high and the workability is impaired. Therefore, the content of C has a lower limit of 0.05% and an upper limit of 0.30%. However, from the viewpoint of the machinability, the upper limit of the content of C is preferably 0.25%, more preferably 0.20%. Furthermore, to easily forge a part by cold working, the upper limit of the content of C is preferably made 0.1%.

Mn is an element useful for raising the hardenability and securing the strength. If the Mn is less than 0.4%, sufficient strength cannot be secured, while if over 3.0%, the strength excessively rises and the workability falls. Therefore, the content of Mn has a lower limit of 0.4% and has an upper limit of 3.0%. Note that, due to the excessive Mn content, the effective hardened case depth is sometimes reduced, so the upper limit of the content of Mn is preferably made not more than 2.5%. The more preferable upper limit of the content of Mn is 2.0%.

Cr is an extremely effective element which forms carbonitrides with the N entering at the time of nitriding and the C in the steel and remarkably raises the hardness of the nitrided case at the surface by precipitation strengthening. However, if excessively including Cr, the effective hardened case depth sometimes becomes thinner. If the content of Cr is less than 0.2%, it is not possible to obtain a sufficiently effective hardened case. On the other hand, if the content of Cr is over 0.9%, the effect of precipitation strengthening becomes saturated and the effective hardened case depth is reduced. Therefore, the content of Cr has a lower limit of 0.2% and an upper limit of 0.9%. Further, the content of Cr preferably has a lower limit of 0.3% and an upper limit of 0.8%.

Al is an element effective for forming a nitride with the N which enters at the time of nitriding, raising the hardness of the nitrided case, and obtaining a deeper effective hardened case depth and is effective for improving the surface hardness. However, if excessively adding Al, the effective hardened case depth sometimes becomes thinner. If the content of Al is less than 0.19%, a sufficient surface hardness cannot be obtained, while even if included in over 0.70%, the effect of addition becomes saturated and the effective hardened case depth is reduced. Therefore, the content of Al has a lower limit of 0.19% and an upper limit of 0.70%. Further, the upper limit of the content of Al is preferably made 0.50%, more preferably 0.30%.

The inventors engaged in further studies based on their discoveries that Al and Cr are effective for hardening a nitrided case, but if excessively added, the effective hardened case depth is reduced.

The inventors uses steel materials with changed contents of Al and contents of Cr as materials to produce cold forged parts, nitrides them, and measures the surface hardness and effective hardened case depth.

The nitriding was performed in an atmosphere of a mixed gas, by volume percentage, of NH₃:N₂:CO₂=50:45:5 at a temperature of 570° C. for a holding time of 10 hours.

The surface hardness was measured in accordance with JIS Z 2244 by the HV0.3 (2.9N) at a position of within 50 μm from the surface at the steel cross-section. Further, the effective hardened case depth was made the distance from the surface layer to a position where the HV becomes 550 referring to JIS G 0557.

As a result of the study, the inventors discovered that it is necessary to control the relationship between the content of Al and the content of Cr. Specifically, it was learned that the effective hardened case depth of the nitrided case is correlated with the total of the atomic concentrations of Al and Cr.

The atomic weight of Cr is 52, while the atomic weight of Al is 27, so in mass %, by 1.9Al+Cr, it is possible to clarify the relationship between the effective hardened case depth of the nitrided case and the surface hardness. Note that, in the formula “1.9Al+Cr”, Al and Cr indicate the content (mass %) of Al in the steel material and the content (mass %) of Cr.

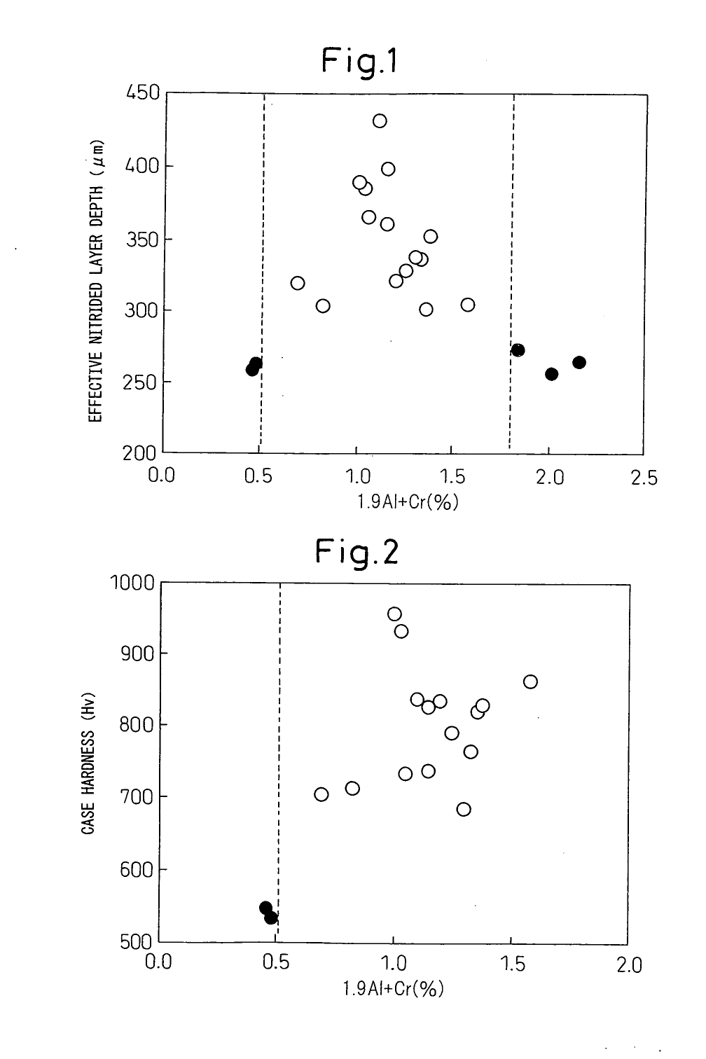

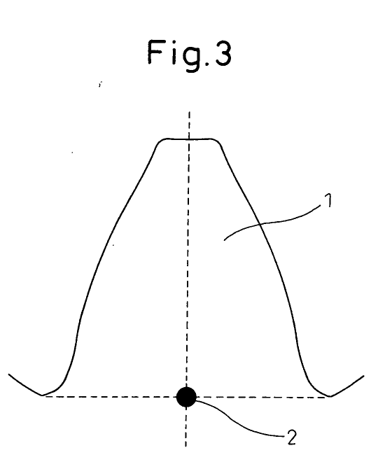

FIG. 1 shows the relationship between the 1.9Al+Cr and the effective hardened case depth. Further, FIG. 2 shows the relationship between the 1.9Al+Cr and the surface hardness. Here, the surface hardness is the hardness at a position 50 μm from the surface at the steel cross-section.

As shown in FIG. 1, if 1.9Al+Cr is less than 0.5% or over 1.8%, a sufficient effective hardened case depth cannot be obtained.

If 1.9Al+Cr is less than 0.5%, the effective hardened case depth is reduced, it is believed, because the precipitation strengthening by carbonitrides of Cr and nitrides of Al cannot be sufficiently obtained. For this reason, as shown in FIG. 2, if 1.9Al+Cr is less than 0.5%, the surface hardness also falls.

On the other hand, if 1.9Al+Cr exceeds 1.8%, the effective hardened case becomes thinner because, it is believed, the diffusion of nitrogen in the steel is obstructed in nitride formation.

Therefore, the range of 1.9Al+Cr has a lower limit of 0.5% and an upper limit of 1.8%.

V is an element which raises the hardenability, forms carbonitrides, and contributes to the strength of the steel. In particular, in the present invention, like Mo, it forms composite carbonitrides with Cr and Al and so is extremely effective for hardening the nitrided case. If the content of V is 0.05% or more, the surface hardness and effective hardened case depth are remarkably improved. On the other hand, if the content of V is over 1.0%, the effect of increase of the surface hardness and effective hardened case depth is saturated. Therefore, the content of V has a lower limit of 0.05% and has an upper limit of 1.0%. Further, the upper limit of the content of V is preferably 0.75% and is more preferably 0.50%.

Mo is an element which raises the hardenability, mainly forms carbides, and contributes to the strength of the steel. In particular, in the present invention, it forms composite carbonitrides with Cr and Al and is extremely effective for hardening of the nitrided case. If making the content of Mo 0.05% or more, the surface hardness and effective hardened case depth are remarkably improved. On the other hand, if the content of Mo is over 0.50%, the effect of increasing the surface hardness and effective hardened case depth is not commensurate with the production costs. Therefore, the content of Mo has a lower limit of 0.05% and has an upper limit of 0.50%. Further, the content of Mo preferably has an upper limit of 0.25%.

Si is an element useful as a deoxidizing agent, but, in nitriding, does not contribute to the improvement of the surface hardness and makes the effective hardened case depth thinner. For this reason, the content of Si is preferably limited to not more than 0.50%. To obtain a deeper effective hardened case, the upper limit of the content of Si is preferably made 0.1%. On the other hand, to remarkably reduce the content of Si, a rise in the production cost would be incurred, so the lower limit of the content of Si is made 0.003%.

Ti and Nb are elements for forming carbonitrides together with the N entering at the time of nitriding and the C in the steel. One or both are preferably added. To raise the hardness of the nitrided case and increase the effective hardened case depth, it is preferable to include Ti and Nb in respective amounts of at least 0.01%. On the other hand, even if including over 0.3% of Ti and Nb, the effect of raising the hardness of the nitrided case and increasing the effective hardened case depth is saturated, so the upper limits of Ti and Nb are preferably 0.3%.

B is an element for improving the hardenability. To raise the strength, it is preferable to include 0.0005% or more. On the other hand, even if the content of B exceeds 0.005%, the effect of improvement of the hardenability is saturated, so the upper limit of the content of B is preferably made 0.005%.

In the present invention, to raise the strength of the nitrided part as a whole, the steel microstructure of the steel for nitriding use is preferably one or both of bainite and martensite.

Bainite and martensite contain large amounts of the alloy elements, in solid solution, required for the precipitation strengthening at the time of nitriding. Therefore, by making the steel microstructure of the material before nitriding include large amounts of bainite and martensite, it is possible to effectively raise the hardness of the nitrided case of the steel material after nitriding by the precipitation strengthening at the time of nitriding.

To sufficiently obtain the advantageous effect of precipitation strengthening, it is preferable to make the area rate of one or a total of both of bainite and martensite of the steel for nitriding use at least 50%. To cause precipitation strengthening more effectively, it is more preferable to make the area rate of one or a total of both of bainite and martensite at least 70%.

Further, the steel microstructure of the nitrided part also, like steel for nitriding use, preferably raises the hardness of the nitrided case by making the area rate of one or a total of both of bainite and martensite 50% or more. To cause precipitation strengthening more effectively, the area rate of one or a total of both of bainite and martensite is more preferably made 70% or more.

Here, the microstructure other than bainite and martensite is preferably made ferrite and pearlite.

The bainite of the steel microstructure can be evaluated by polishing the steel to a mirror surface, etching it by a Nital solution and observing the surface under an optical microscope. The surface is observed before cold forging or after hot forging. The location of observation, if a steel rod, is a position of ¼ of the diameter. For example, in the case of a gear, the position of reference numeral 2 in FIG. 3 may be used.

The area rate of the steel microstructure may be found by using an optical microscope to observe five fields at powers of 500, obtaining photographs, visually determining the bainite parts, and finding the area rate of the bainite parts in the photographs as a whole utilizing image analysis. The same applies for the area rate of martensite.

Note that, the steel for nitriding use of the present invention need not be hot worked. It may also be cold worked, machined, etc. to obtain the final product shape, then nitrided to obtain a nitrided part. In this case, at the stage of the steel for nitriding use, the area rate of one or a total of both of bainite and martensite is preferably at least 50%.

Further, even if working the steel for nitriding use by hot forging or other hot working and, if necessary, machining it etc. to obtain the final product shape, at the stage of the steel for nitriding use, the area rate of one or a total of both of bainite and martensite is preferably at least 50%.

This is because, due to the final hot working, it is easy to make the area rate of one or a total of both of bainite and martensite 50% or more.

A nitrided part obtained by working the steel for nitriding use prescribed by the present invention by hot working or cold working, then machining it in accordance with need, then nitriding it exhibits the effects of the present invention in the same way.

Further, it is also possible to work a steel slab having a composition of ingredients similar to the above steel for nitriding use by hot forging or other hot working and further, in accordance with need, machine it etc. to obtain the final product shape and then to nitride it to obtain a nitrided part. In this case, at the stage of the steel slab, the area rate of one or a total of both of bainite and martensite does not have to be 50% or more. Note that, the steel slab may be used as cast or may be cast, then hot forged, hot rolled, or otherwise hot worked.

The nitrided part of the present invention, by gas nitriding, plasma nitriding, gas nitrocarburizing, salt bath nitrocarburizing, or other nitriding, has the superior properties of an effective hardened case depth of 300 μm or more and a surface hardness of 700 HV or more.

Further, the effective hardened case depth of the nitrided part of the present invention is preferably 450 μm or less. This is because even if the effective hardened case depth is over 450 μm, the nitriding time only becomes longer. The improvement of the fatigue strength of the nitrided part becomes saturated.

Further, the upper limit of the surface hardness of the nitride part of the present invention is not particularly limited, but is preferably 1000 HV. This is because even if the surface hardness is over 1000 HV, the improvement of the fatigue strength of the nitrided part is saturated.

Note that, the surface hardness is the Vicker's hardness and is measured based on JIS Z 2244.

According to nitrocarburizing, if a part of a usual size, it is possible to obtain superior properties of an effective hardened case depth of 300 μm or more and a surface hardness of 700 HV or more by a treatment time of within 10 hours.

Further, even with a large sized part which required several weeks of treatment time with nitriding in the past, by using nitrocarburizing, it is possible to obtain superior properties of an effective hardened case depth of 300 μm or more and a surface hardness of 700 HV or more in about one week.

Next, the methods of production of the steel for nitriding use and nitrided part of the present invention will be explained.

The steel for nitriding use is mainly produced by hot rolling. Further, the nitrided part is mainly produced by hot forging. Further, when making the area rate of one or a total of both of bainite and martensite 50% or more, the heating temperature of the hot rolling or hot forging and the cooling rate are controlled.

If the heating temperature before hot rolling or hot forging is less than 1000° C., the deformation resistance may become greater and the cost may become higher. Further, if the added alloy elements are not sufficiently solubilized, the hardenability is liable to fall and the bainite percentage is liable to fall. Therefore, the heating temperature before rolling or before forging is preferably made 1000° C. or more.

On the other hand, if the heating temperature exceeds 1300° C., the austenite grain boundaries become coarser, so the heating temperature is preferably 1300° C. or less.

Furthermore, to prevent a drop in the percentages of the bainite and martensite and suppress the formation of ferrite and pearlite microstructures, it is preferable to control the cooling rate after the hot rolling or hot forging to 500° C. or less.

If the lower limit of the cooling rate down to 500° C. or less becomes less than 0.1° C./s, the area rate of the bainite and the martensite may decrease and ferrite and pearlite microstructures may be formed.

Further, the upper limit of the cooling rate down to 500° C. or less is preferably fast so as to raise the area rate of the martensite. However, from the viewpoint of the workability, when suppressing the formation of martensite, it is preferable to make the upper limit of the cooling rate 10° C./s or less.

Therefore, the cooling rate after hot rolling or hot forging until being cooled to 500° C. or less is preferably made a range of 0.1 to 10° C.

Further, the steel for nitriding use of the present invention produced by hot rolling can be used and cold worked (for example, cold forged or machined) into a part of a predetermined shape to produce a nitrided part.

By nitriding a part such as for example a gear using the steel for nitriding use of the present invention, it is possible to obtain a nitrided part provided with a hardened case of superior properties which suppresses heat treatment distortion while having an effective hardened case depth of 300 μm or more and a surface hardness of 700 HV or more.

The nitrided part provided with such a hardened case of superior properties is also superior in fatigue strength.

As the nitriding, gas nitriding, plasma nitriding, gas nitrocarburizing, and salt bath nitrocarburizing may be mentioned.

To obtain a nitrided case having a surface hardness of 700 HV or more and an effective hardened case depth of 300 μm or more, when performing gas nitriding, for example, the steel is held in a 540° C. ammonia atmosphere for 20 hours or more.

In particular, as the nitriding, when using, for example, general gas nitrocarburizing at 570° C. using an N₂+NH₃+CO₂ mixed gas, it is possible to obtain the above-mentioned nitrided case in a 10 hour or so treatment time.

That is, by treating a part using the steel for nitriding use of the present invention as a material or a part obtained by hot working a steel slab having ingredients in the same range as the steel for nitriding use of the present invention by nitrocarburizing in an industrially practical time, it is possible to obtain a sufficient surface hardness and a deeper effective hardened case compared with the case of treating conventional steel for nitriding use by nitrocarburizing for the same time.

### EXAMPLES

Next, the present invention will be explained further by examples, but the conditions of the examples are an illustration of one set of conditions employed for confirming the workability and advantageous effects of the present invention. The present invention is not limited to this illustration of the set of conditions. The present invention can employ various conditions so long as not outside of the gist of the present invention and achieving the object of the present invention.

First, steels having the chemical composition shown in Table 1 were smelted. In Table 1, the underlined numerical values indicate values outside the range of the present invention.

TABLE 1

| | Chemical composition (mass %) | | | | | | | | | | 1.9Al + | |
|---|---|---|---|---|---|---|---|---|---|---|---|---|
| No. | C | Mn | Cr | Al | V | Mo | Si | Ti | Nb | B | Cr | Remarks |
| 1 | 0.13 | 0.8 | 0.67 | 0.17 | 0.78 | 0.14 | 0.15 | | | | 0.99 | Inv. ex. |
| 2 | 0.06 | 1.1 | 0.22 | 0.60 | 0.09 | 0.49 | 0.06 | | | | 1.36 | Inv. ex. |
| 3 | 0.08 | 2.0 | 0.80 | 0.21 | 0.22 | 0.50 | 0.09 | | | | 1.20 | Inv. ex. |
| 4 | 0.10 | 1.2 | 0.85 | 0.25 | 0.16 | 0.17 | 0.04 | | | | 1.33 | Inv. ex. |
| 5 | 0.19 | 0.6 | 0.77 | 0.19 | 0.49 | 0.16 | 0.007 | | | | 1.13 | Inv. ex. |
| 6 | 0.26 | 0.4 | 0.56 | 0.22 | 0.54 | 0.23 | 0.19 | | | | 0.98 | Inv. ex. |
| 7 | 0.22 | 0.8 | 0.43 | 0.38 | 0.44 | 0.20 | 0.09 | | | | 1.15 | Inv. ex. |
| 8 | 0.11 | 0.9 | 0.91 | 0.26 | 0.38 | 0.06 | 0.07 | | | | 1.40 | Inv. ex. |
| 9 | 0.12 | 0.8 | 0.78 | 0.27 | 0.46 | 0.49 | 0.09 | | | | 1.29 | Inv. ex. |
| 10 | 0.11 | 0.8 | 0.65 | 0.16 | 0.41 | 0.34 | 0.005 | | | | 0.95 | Inv. ex. |
| 11 | 0.14 | 0.9 | 0.61 | 0.26 | 0.41 | 0.22 | 0.10 | 0.26 | | | 1.10 | Inv. ex. |
| 12 | 0.13 | 0.7 | 0.39 | 0.48 | 0.46 | 0.22 | 0.09 | | 0.24 | | 1.30 | Inv. ex. |
| 13 | 0.27 | 0.6 | 0.41 | 0.44 | 0.40 | 0.14 | 0.05 | 0.02 | 0.03 | | 1.25 | Inv. ex. |
| 14 | 0.19 | 0.5 | 0.58 | 0.30 | 0.14 | 0.43 | 0.40 | 0.07 | 0.05 | 0.0009 | 1.15 | Inv. ex. |
| 15 | 0.12 | 1.1 | 0.45 | 0.49 | 0.15 | 0.47 | 0.28 | | | 0.0040 | 1.38 | Inv. ex. |
| 16 | 0.005 | 0.9 | 0.68 | 0.31 | 0.12 | 0.11 | 0.09 | | | | 1.27 | Comp. ex. |
| 17 | 0.40 | 1.0 | 0.74 | 0.26 | 0.12 | 0.12 | 0.20 | | | | 1.23 | Comp. ex. |
| 18 | 0.18 | 0.1 | 0.57 | 0.37 | 0.07 | 0.16 | 0.31 | | | | 1.27 | Comp. ex. |
| 19 | 0.25 | 4.1 | 0.73 | 0.22 | 0.10 | 0.10 | 0.28 | | | | 1.15 | Comp. ex. |
| 20 | 0.24 | 0.8 | 1.80 | 0.11 | 0.08 | 0.15 | 0.40 | | | | 2.01 | Comp. ex. |
| 21 | 0.16 | 0.6 | 0.42 | 0.03 | 0.08 | 0.14 | 0.08 | | | | 0.48 | Comp. ex. |
| 22 | 0.15 | 0.7 | 0.10 | 0.19 | 0.09 | 0.12 | 0.11 | | | | 0.46 | Comp. ex. |
| 23 | 0.22 | 0.8 | 0.38 | 0.23 | 0.02 | 0.02 | 0.19 | | | | 0.82 | Comp. ex. |
| 24 | 0.23 | 0.8 | 0.52 | 0.35 | 0.09 | 0.16 | 0.89 | | | | 1.19 | Comp. ex. |
| 25 | 0.12 | 0.6 | 0.48 | 0.88 | 0.11 | 0.10 | 0.22 | | | | 2.15 | Comp. ex. |
| 26 | 0.11 | 0.9 | 0.81 | 0.54 | 0.10 | 0.12 | 0.20 | | | | 1.84 | Comp. ex. |

Underlines mean outside range of present invention.
Blank fields mean deliberately not included.

Part of these steels were hot rolled to obtain rods of 10 mm diameter. Further, in part of the steels, steel pieces of diameters of 25 mm were heated to 1200 to 1250° C., hot forged, then cooled by a cooling rates of 1 to 10° C./s to obtain hot forged parts having gear shapes of thicknesses of 10 mm and diameters of 35 mm.

The rods produced by the hot rolling and the hot forged parts were measured for hardness in accordance with JIS Z 2244. The measured locations were machined and polished so that the L cross-section of the test pieces were exposed and the HV0.3(2.9N) was measured at a position of ¼ of the diameter.

Further, for the hardness after hot forging, the HV0.3 was measured for the position of reference numeral 2 in FIG. 3.

The area rate of the bainite and martensite of the rod and hot forged part produced by hot rolling was found by polishing the steel to a mirror surface, etching it by a Nital solution, using an optical microscope to observe five fields of regions corresponding to positions of measurement of the hardness at powers of 500, obtaining photographs, visually determining the bainite parts and martensite parts, and finding the area rate of the parts by image analysis.

Furthermore, using the hot rolled rods as materials, cold forged parts of diameters of 14 mm and thicknesses of 10 mm were produced and treated by gas nitrocarburizing.

Hot forged parts were machined to obtain clean surfaces of the gear shapes and then were treated by gas nitriding. The conditions of the gas nitrocarburizing were an atmosphere of, by volume percentage, a mixed gas of NH₃:N₂:CO₂=50:45:5, a temperature of 570° C., and a holding time of 10 hours.

After the nitrocarburizing, the surface hardness was measured. The surface hardness was HV0.3 (2.9N) at a position of 50 μm from the surface and was measured based on JIS Z 2244.

Further, the effective hardened case depth is based on JIS G 0557 and is the distance measured from the surface layer to a position where the HV becomes 550.

The results are shown in Table 2. Here, the hardness after working in Table 2 is the average value of the hardness after hot rolling and the hardness after hot forging. Further, the surface hardness and effective hardened case depth are the results obtained by measurement after nitrocarburizing.

TABLE 2

| | | Bainite + | Hardness | | Effective | |
|---|---|---|---|---|---|---|
| | | martensite | after hot | Surface | hardened | |
| | | area rate | working | hardness | case depth | |
| No. | Manufacturing process | (%) | (HV) | (HV) | (μm) | Remarks |
| 1 | Hot forging | 75 | 317 | 958 | 434 | Inv. ex. |
| 2 | Hot rolling, cold forging | 55 | 201 | 821 | 302 | Inv. ex. |
| 3 | Hot forging | 100 | 344 | 836 | 322 | Inv. ex. |
| 4 | Hot forging | 75 | 287 | 766 | 337 | Inv. ex. |
| 5 | Hot forging | 60 | 306 | 815 | 385 | Inv. ex. |
| 6 | Hot forging | 60 | 367 | 806 | 399 | Inv. ex. |
| 7 | Hot forging | 70 | 377 | 829 | 399 | Inv. ex. |
| 8 | Hot rolling, cold forging | 70 | 279 | 830 | 321 | Inv. ex. |
| 9 | Hot forging | 100 | 281 | 897 | 378 | Inv. ex. |
| 10 | Hot rolling, cold forging | 100 | 272 | 905 | 375 | Inv. ex. |
| 11 | Hot forging | 80 | 347 | 837 | 432 | Inv. ex. |
| 12 | Hot forging | 80 | 336 | 706 | 338 | Inv. ex. |
| 13 | Hot forging | 45 | 237 | 792 | 329 | Inv. ex. |
| 14 | Hot forging | 75 | 375 | 739 | 361 | Inv. ex. |
| 15 | Hot forging | 90 | 363 | 830 | 353 | Inv. ex. |
| 16 | Hot forging | 30 | 105 | 676 | 288 | Comp. ex. |
| 17 | Hot forging | 100 | 602 | 719 | 339 | Comp. ex. |
| 18 | Hot rolling, cold forging | 25 | 142 | 691 | 259 | Comp. ex. |
| 19 | Hot forging | 100 | 560 | 796 | 258 | Comp. ex. |
| 20 | Hot forging | 100 | 548 | 834 | 281 | Comp. ex. |
| 21 | Hot rolling, cold forging | 35 | 178 | 534 | 263 | Comp. ex. |
| 22 | Hot rolling, cold forging | 25 | 132 | 547 | 259 | Comp. ex. |
| 23 | Hot rolling, cold forging | 40 | 228 | 581 | 281 | Comp. ex. |
| 24 | Hot forging | 90 | 486 | 644 | 243 | Comp. ex. |
| 25 | Hot rolling, cold forging | 30 | 141 | 923 | 265 | Comp. ex. |
| 26 | Hot rolling, cold forging | 60 | 244 | 846 | 234 | Comp. ex. |

In Table 2, the invention examples of Nos. 1 to 15 are all confirmed to have surface hardnesses of at least 700 HV and effective hardened case depths of at least 300 μm.

As opposed to this, the comparative examples of Nos. 16 and 18 have contents of C and contents of Mn less than the lower limits of the present invention, so the hardnesses after hot working are below 200 HV and sufficient strengths cannot be obtained.

Nos. 17 and 19 have contents of C and contents of Mn over the upper limits of the present invention, so have hardnesses after hot working of over 500 HV and have problems in workability.

Nos. 20 and 22 have contents of Cr outside the range of the present invention, while Nos. 21 and 25 have contents of Al outside the range, so the effective hardened cases are thin and are less than 300 μm.

No. 26 has an 1.9Al+Cr of over 1.8, so the effective hardened case becomes thin.

No. 23 has contents of V and Mo of less than the lower limits of the present invention, while No. 24 has a content of Si of over the upper limit of the present invention, so the respective effective hardened case depths become thin.

Note that, the above explanation only illustrates embodiments of the present invention. The present invention may be modified in various ways within the scope of the description of the claims.

### INDUSTRIAL APPLICABILITY

According to the present invention, it is possible to provide steel for nitriding use which may be nitrided to obtain a deep effective hardened case and can exhibit remarkable effects in industry.

Further, according to the present invention, when producing a nitrided part having a nitrided case which is sufficiently hard and has a deep effective nitrided case, it is possible to reduce the number of manhours for machining before nitriding and to reduce the heat treatment distortion at the time of hardening treatment and possible to reduce the cost of manufacturing a nitrided part having a high fatigue strength. The present invention has great value in application in industry.

### REFERENCE SIGNS LIST

1. One tooth in gear part
2. Position of measurement of hardness after hot forging

1. Steel for nitriding use characterized by containing, by mass %,
C: 0.05 to 0.30%,
Si: 0.003 to 0.50%,
Mn: 0.4 to 3.0%,
Cr: 0.2 to 0.9%,
Al: 0.19 to 0.70%,
V: 0.05 to 1.0%, and
Mo: 0.05 to 0.50%,
having contents of Al and Cr satisfying
0.5%≦1.9Al+Cr≦1.8%, and
having a balance of Fe and unavoidable impurities.

2. Steel for nitriding use as set forth in claim 1, characterized by further containing, by mass %, one or both of
Ti: 0.01 to 0.3% and
Nb: 0.01 to 0.3%.

3. Steel for nitriding use as set forth in claim 1, characterized by further containing, by mass %,
B: 0.0005 to 0.005%.

4. Steel for nitriding use as set forth in claim 1, characterized in that an area rate of one or a total of both of bainite and martensite is 50% or more.

5. Steel for nitriding use as set forth in claim 3, characterized in that an area rate of one or a total of both of bainite and martensite is 50% or more.

6. A nitrided part characterized by containing, by mass %,
C: 0.05 to 0.30%,
Si: 0.003 to 0.50%,
Mn: 0.4 to 3.0%,
Cr: 0.2 to 0.9%,
Al: 0.19 to 0.70%,
V: 0.05 to 1.0%, and
Mo: 0.05 to 0.50%,
having contents of Al and Cr satisfying
0.5%≦1.9Al+Cr≦1.8%,
having a balance of Fe and unavoidable impurities,
having a nitrided case at its surface, and
having a surface hardness of 700 HV or more.

7. A nitrided part as set forth in claim 6 characterized by further containing, by mass %, one or both of
Ti: 0.01 to 0.3% and
Nb: 0.01 to 0.3%.

8. A nitrided part as set forth in claim 6 characterized by further containing, by mass %:
B: 0.0005 to 0.005%

9. A nitrided part as set forth in claim 6, characterized in that an area rate of one or a total of both of bainite and martensite is 50% or more.

10. A nitrided part as set forth in claim 8, characterized in that an area rate of one or a total of both of bainite and martensite is 50% or more.

11. A nitrided part as set forth in claim 6, characterized in that said nitrided case has an effective hardened case depth of 300 to 450 μm.

12. A nitrided part as set forth in claim 8, characterized in that said nitrided case has an effective hardened case depth of 300 to 450 μm.

13. A nitrided part as set forth in claim 9, characterized in that said nitrided case has an effective hardened case depth of 300 to 450 μm.
